(19) United States
(12) Patent Application Publication
(10) Pub. No.: US 2011/0271848 A1
(43) Pub. Date: Nov. 10, 2011

(54) Steamer with hi-dome lid

(75) Inventor: Johnnie Kuo, Taipei (TW)

(73) Assignee: ASIA GLOBAL ENTERPRISES, LTD. (TAIWAN), Taipei (TW)

(21) Appl. No.: 12/662,794

(22) Filed: May 4, 2010

(51) Int. Cl. A47J 27/04; A21B 1/00

(52) U.S. Cl. 99/410; 126/274

(57) ABSTRACT

A steamer includes a steamer body and a plate stacker assembly. The steamer body includes a dutch oven and a hi-dome lid. The dome lid is integrally formed for openably closing onto an open top of the dutch oven to define a relatively high space in between the dutch oven and the dome lid for receiving the steaming rack assembly therein. The steaming rack assembly includes two or more plate stacker, which can be detachably stacked on one another. Foods held in dishes can be positioned on each of the steaming racks and be steamed in the steamer body at the same time. With the integrally formed dome lid, vapor produced by boiled water in the dutch oven does not easily escape from the steamer body and the foods can be evenly heated and cooked through closed steaming, making the steamer environmentally friendly and energy saving.

### FIELD OF THE INVENTION

The present invention relates to a food steamer, and more particularly to a steamer with an integrally hi-dome lid, so that vapor produced by boiled water in the steamer does not easily escape therefrom and foods positioned in the steamer can be evenly heated and cooked through closed steaming, making the steamer environmentally friendly and energy saving.

### BACKGROUND OF THE INVENTION

Recent medical researches indicate that steaming is the best way of cooking food because nutrients of food would not lose and no health-hazardous substance would be produced in the process of steaming. A commonly seen food steamer mainly includes a lid, one or more steamer bodies, and a steaming rack. This type of conventional food steamer has been used for a long time and is frequently seen in people's daily life. Almost every home has one or more steamers. To use the steamer, foods to be cooked are separately position in the vertically stacked steamer bodies, and the stacked steamer bodies are positioned on a pan having an amount of water contained therein. The pan is then heated to boil the water and produce vapor, so that foods in the stacked steamer bodies are steamed and cooked.

While the conventional steamer is convenient for use and widely welcomed among users, the steamer bodies thereof are not a sealed structure. A large part of the produced vapor tends to escape from the steamer bodies via joints therebetween to cause waste of a large quantity of usable heat energy. Therefore, the conventional steamer has relatively low utilization efficiency. Further, the vapor escaped from the steamer bodies in the process steaming would diffuse through the room to adversely affect the working or living environment. In some worse conditions, people nearby the steamer would even be scalded by the escaped vapor.

Other types of cookers, such as a stew pan, a wok, etc., are also frequently used as a substitute for the conventional steamer. However, these cookers usually have a relatively low lid and can only define a relatively limited space in between the dutch oven and the lid. Therefore, only one dish of food can be steamed in the limited steaming space each time. A lot of time must be taken to steam different dishes one by one with the wok or the stew pan. Since the conventional food steamer and other alternates thereof require more time and consume more heat to steam the foods, they are not only non-economical for use and have low utilization efficiency, but also fail to meet the requirements of environmental protection and energy saving.

It is therefore tried by the inventor to develop a food steamer with hi-dome lid to eliminate the drawbacks existed in the conventional steamer.

### SUMMARY OF THE INVENTION

A primary object of the present invention is to provide a steamer with hi-dome lid, so as to eliminate the drawbacks existed in the conventional steamer.

To achieve the above and other objects, the steamer according to the present invention includes a steamer and a plate stacker assembly. The steamer includes a dutch oven and a hi-dome lid. The dome lid is integrally formed for openably closing onto an open top of the dutch oven to define a relatively high space in between the dutch oven and the dome lid for receiving the plate stacker assembly therein. The plate stacker assembly includes two or more steaming racks, which can be detachably stacked on one another. Foods held in dishes can be positioned on each of the steaming racks and be steamed in the steamer at the same time.

With the integrally formed dome lid, vapor produced by boiled water in the dutch oven does not easily escape from the steamer and the foods on the steaming rack assembly can be evenly heated and cooked through closed steaming. Therefore, the steamer of the present invention is environmentally friendly and energy saving.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a steamer with hi-dome lid according to the present invention;

FIG. 2 shows plate stacker for the present invention before being stacked on one another;

FIG. 3 is a cutaway view of the present invention;

FIG. 4 is a sectional view showing the present invention in use; and

FIG. 5 is a sectional view showing the dutch oven and the hi-dome lid for the present invention are nested for packaging, transporting or storage.

### DETAILED DESCRIPTION OF THE PREFERRED EMBODIMENTS

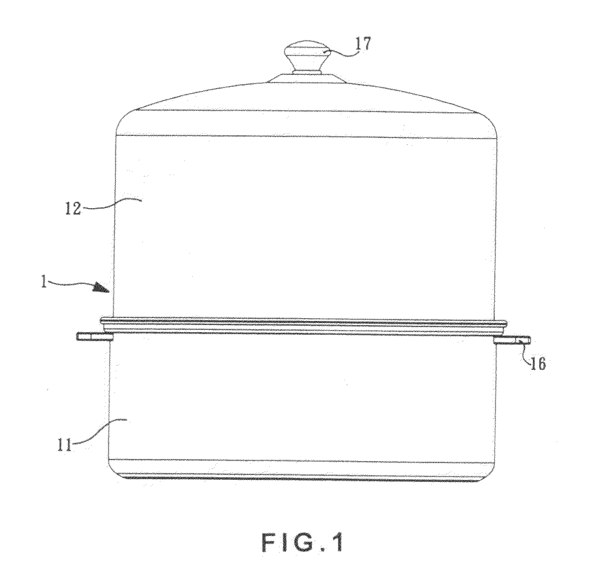

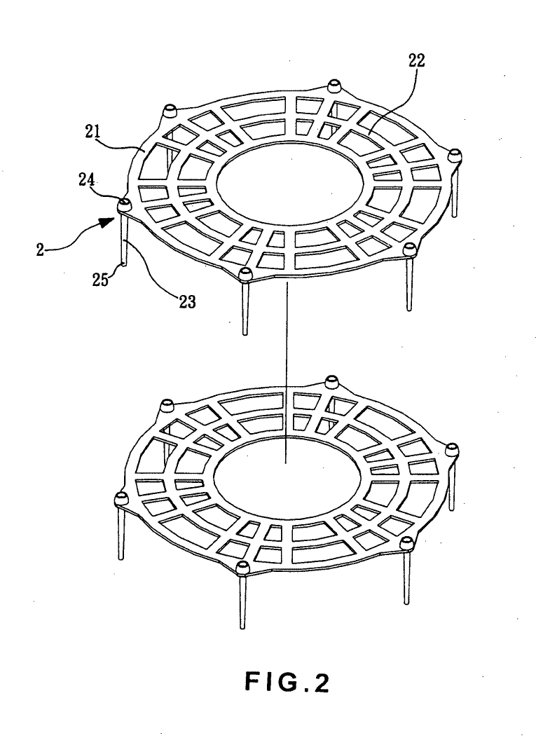

Please refer to FIGS. 1 to 3. The present invention is a steamer with hi-dome lid and includes a steamer body 1 and a steaming rack assembly 2.

The steamer body 1 includes a dutch oven 11 and a hi-dome lid 12. The dome lid 12 is integrally formed for openably closing onto an open top of the dutch oven 11, so that a relatively high space 13 is defined in between the closed dutch oven 11 and dome lid 12. In practical implementation, the steamer body 1 can be cylindrical in shape. The dutch oven 11 and the dome lid 12 are respectively provided along a rim with a radially outward extended flange 14, 15, such that the flange 15 of the dome lid 12 can be rested on the flange 14 of the dutch oven 11 when the dome lid 12 is fully closed on the open top of the dutch oven 11. The dutch oven 11 is externally provided near the open top thereof with two diametrically opposite handles 16. The dome lid 12 is provided on a top thereof with a centered knob 17, and can be provided at predetermined positions with vents (not shown), if necessary.

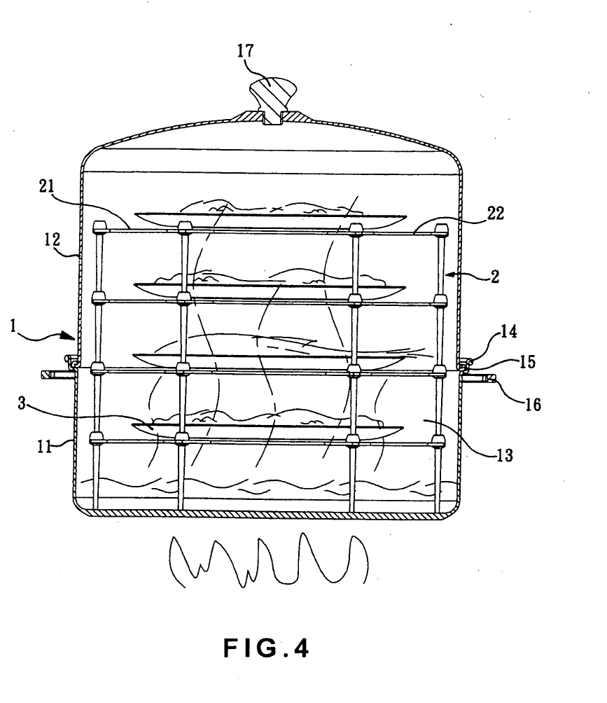

The steaming rack assembly 2 includes two or more plate stacker 21 that can be vertically detachably stacked on one another, and the plate stacker 21 can be positioned in high space 13 in the steamer body 1. Each of the plate stacker 21 includes a round perforated plate 22, and a plurality of legs 23 spaced along and downward extended from an outer peripheral edge of the perforated plate 22. Each of the legs 23 has an upper end located above the perforated plate 22 and formed into a concave to define a leg insertion space 24, and a lower end located below the perforated plate 22 and formed into a tapered leg tip 25. To stack the plate stacker 21, simply insert the leg tips 25 of an upper plate stacker 21 into the leg insertion spaces 24 of a lower plate stacker 21. As can be seen in FIG. 4, one or more dishes 3 holding different foods can be positioned on each of the stacked plate stacker 21 at the same time, so that the foods can be steamed efficiently.

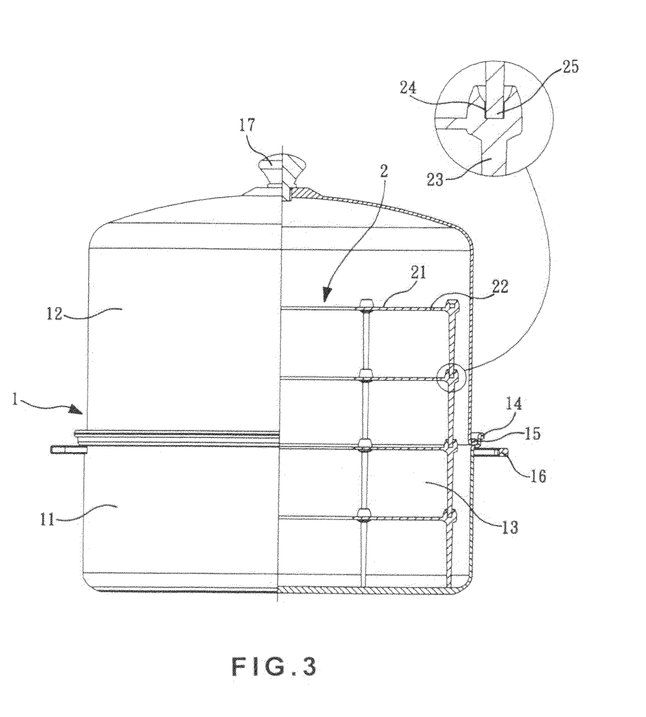

As can be seen in FIG. 3, the steamer body 1 can be easily assembled for use. When the particularly designed height-increased dome lid 12 is closed onto the open top of the dutch oven 11, a relatively high space 13 is defined in between the closed dutch oven 11 and dome lid 12 for receiving the steaming rack assembly 2 therein. The dutch oven 11 can also be used with a general lower cover (not shown) to serve as a stew pan or the like for cooking foods in other different ways. Therefore, the food steamer of the present invention is very practical for use.

Please refer to FIG. 4. To use the present invention as a steamer, first pour an adequate amount of water into the dutch oven 11. Then, position a first plate stacker 21 in the dutch oven 11 and put dishes 3 with foods on the perforated plates 22 of the first plate stacker 21. Thereafter, stack a second plate stacker 21 on the first plate stacker 21 by aligning and inserting the tapered leg tips 25 of the second plate stacker 21 into the leg insertion spaces 24 on the first plate stacker 21 for holding other dishes 3 with foods. When all required plate stacker 21 have been sequentially stacked on one another and dishes 3 holding different foods have been positioned on the plate stacker 21, the dome lid 12 is closed onto the dutch oven 11 with the radially extended flanges 14, 15 pressed against each other. Thus, the steaming rack assembly 2 and the foods to be steamed are together received in the high space 13 in the steamer body 1.

Since the steamer body 1 includes only the dutch oven 11 and one integrally formed hi-dome lid 12, clearances on the steamer body 1 to cause steam leakage are effectively reduced. When the dutch oven 11 is heated to steam the foods, vapor produced by the boiled water is sealed in the steamer body 1 without diffusing through the room to adversely affect the working or living environment or waste heat energy. Since the plate stacker 21 of the steaming rack assembly 2 respectively include a perforated plate 22, vapor produced by the boiled water in the process of steaming can easily pass through the perforated plates 22 to flow upward, so that foods on each of the plate stacker 21 positioned in the high space 13 can be evenly heated at the same time and be well cooked through closed steaming.

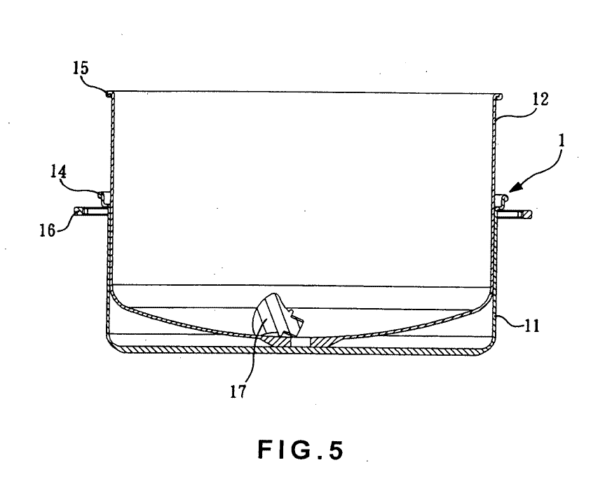

Please refer to FIG. 5. In designing the present invention, the dutch oven 11 of the steamer body 1 can have an inner diameter larger than an outer diameter of the dome lid 12. The dome lid 12 can be turned upside down and nested in the dutch oven 11 to largely reduce the space occupied by the steamer body 1 when it is not in use, allowing the steamer body 1 not in use to be conveniently packaged, transported or stored. Further, in designing or manufacturing the present invention, the dome lid 12 can have an overall height larger than a depth of the dutch oven 11, so that the upside-down dome lid 12 nested in the dutch oven 11 can still upward extend beyond the rim of the dutch oven 11 to enable easy separation of the nested dome cover 12 from the dutch oven 11 by applying a minor force to pull the dome lid 12 out of the dutch oven 11.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A steamer with hi-dome lid, comprising:
a steamer body including a dutch oven and a hi-dome lid; and the dome lid being integrally formed for openably closing onto an open top of the dutch oven to thereby define a relatively high space in between the closed dutch oven and dome lid; and
a steaming rack assembly for positioning in the steamer body and including more than one steaming rack; and the steaming racks being vertically detachably stacked on one another, such that different foods held in dishes can be positioned on each of the steaming racks to be steamed at the same time;
whereby, with the integrally formed height-increased dome cover closed onto the pan, clearances on the steamer body that would cause vapor leakage are effectively reduced, vapor produced in the process of steaming does easily escape from the steamer body and foods on the steaming racks in the steamer body are evenly and efficiently steamed, making the food steamer environmentally friendly and energy saving.

2. The steamer with hi-dome lid as claimed in claim 1, wherein the dome lid has a height larger than a depth of the dutch oven, and the dutch oven has an inner diameter larger than an outer diameter of the dome lid, allowing the dome lid in an upside down position to be nested in the dutch oven.

3. The steamer with hi-dome lid as claimed in claim 1, wherein the dutch oven and the dome lid are respectively provided on a rim thereof with a radially outward extended flange, and the flange of the dome lid being able to rest on the flange of the dutch oven.

4. The steamer with hi-dome lid as claimed in claim 1, wherein the steamer body is cylindrical in shape, the pan is externally provided near the open top with two diametrically opposite handles, and the dome lid is provided on a top with a centered knob and at predetermined positions with vents.

5. The steamer with hi-dome lid as claimed in claim 1, wherein each of the steaming racks includes a perforated round plate and a plurality of legs spaced along and downward extended from an outer peripheral edge of the perforated round plate; each of the legs having an upper end located above the perforated round plate and formed into a concave to define a leg insertion space, and a lower end located below the perforated round plate and formed into a tapered leg tip; and the taper leg tips on an upper plate stacker being able to separately align with and detachably insert into the leg insertion spaces on a lower steaming rack.
